(19) United States
(12) Patent Application Publication
(10) Pub. No.: US 2006/0138690 A1
(43) Pub. Date: Jun. 29, 2006

(54) Method for producing profiles made of thermoplastic material

(75) Inventors: Meinhard Schwaiger, Linz (AT); Hugo Verniest, Beernem (BE)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: TECHNOPLAST KUNSTSTOFFTECHNIK GMBH & CO. KG

(21) Appl. No.: 11/159,400

(22) Filed: Jun. 23, 2005

(30) Foreign Application Priority Data
Jun. 25, 2004 (AT) A 1089/2004

(51) Int. Cl. B29C 47/92

(52) U.S. Cl. 264/40.6; 264/40.7; 425/144; 425/149

(57) ABSTRACT

The invention relates to a method and the thus required devices for automated process and quality monitoring of an extrusion plant and an integrated closed-loop process control system for timely correction of process parameters as a result of fluctuations in the properties of the raw material or parameter fluctuations of the extrusion system in order to ensure an even quality of the produced profile.

### FIELD OF THE INVENTION

The invention relates to a method and the thus required devices for fully automatic process and quality monitoring of an extrusion plant and an integrated closed-loop process control system for timely correction of process parameters as a result of fluctuations in the properties of the raw material or parameter fluctuations of the extrusion system.

Numerous efforts have been undertaken to monitor the extrusion process and to ensure an even quality of the produced profile. A similarly functional method as in the injection molding process has not yet been available for the extrusion process. The present invention describes a method and the thus required devices which allow monitoring the production process and the quality of the profile on the one hand, and the automated closed-loop process control on the other hand.

Plastic profiles made of thermoplastic materials (which is preferably from PVC in this case) are produced in the so-called extrusion process as endless profile bars. Such plastic profiles are used for the production of windows with plastic frames. Very high demands are placed on the quality of profiles which are produced in the extrusion process and are used in the production of windows with plastic frames. It is therefore necessary to meet very narrow dimensional tolerances and to ensure long-lasting visual properties such as even gloss over long production periods. This can only be ensured when the production systems and dies are in an optimal state and are adjusted carefully to the starting material to be processed. The extrusion die is adjusted in a separate process section to the processed material with the extruder used in the production process. This process is performed once during the service life of an extrusion die and is completed with the release for production. During the actual utilization phase of the extrusion die, the production process must be kept stable and the process parameters within very narrow limits (operational state) so as to ensure that a profile can be produced in even quality. It is a known fact however that fluctuations in the raw material are unavoidable in the on-going production process. These fluctuations in the raw material can have an influence on the quality of the product or on the required process parameters.

One basic precondition for an even quality of the extruded profile made of thermoplastic material is the even rheological property of the melt which is guided by the extruder to the die. In order to describe these properties of the melt it is necessary to detect and process Theological parameters.

In accordance with the state of the art and for the purpose of monitoring the operational state of the extruder during the production, the die pressure (pressure of melt at the outlet from the extruder) is measured and recorded by means of a pressure sensor and the mass temperature (melt temperature) is measured and recorded by means of temperature detectors (temperature sensors), which sensors are situated in an adapter arranged between the extruder and the die. This operational state depends on the material and the die. The properties of the melt cannot be described from a rheological viewpoint with the measured parameters of mass pressure and mass temperature.

Numerous efforts have been undertaken for determining the rheological properties of the melt. The detection of the rheological properties of the plastic melt under production conditions by including the production machine is relevant for the present application.

### PRIOR ART

The specialist article “Sensorentwicklung und Automatisierungstendenzen bei der Kunststoffaufbereitung” (Development of sensors and automation tendencies in the preparation of plastic materials) (H.-G. Fritz; S. Ultsch), Kunststoffe, Carl Hanser Verlag, Munich, Vol. 81, No. 1, 1991, describes and illustrates a rheometric system for detecting rheological physical characteristics functions has been illustrated and described. The illustrated rheometric systems are based on continual taking of samples during the production process at only one place within the melt flow in the extruder and the conveyance of melt to the rheometer and the return conveyance by means of a gear pump. Such systems are unsuitable in the case of PVC extrusion because any additional introduction of shearing energy (e.g. as a result of the conveyance of the melt by means of the gear pump) would change the rheological properties of the melt. A permanent loss of material would ensue if the branched-off melt flow would not be returned.

WO 96/14930 (HIBRIGHT HOLDINGS LTD; Fleming Donald; Addleman Robert Leslie), May 23, 1996 discloses process monitoring by means of the determination of rheological properties of plastic melts in an extruder, which occurs in such a way that melt material is taken during the measurement and the rheological properties are determined in a separate measuring apparatus. This system cannot be used in the case of PVC processing.

The specialist article “Neues Konzept zur On-line-Rheometrie in Echtzeit” (New concept for on-line rheometry in real time) (A. Gbttfert), Kunststoffe 81, Carl Hanser Verlag, Munich, No. 1, 1991, discloses an online measuring system for determining rheological parameters of plastic melts. In this method, a melt flow is branched off by the extruder, conveyed by means of a gear pump to the actual measuring device and measured. The disadvantageous aspects are the permanent loss of material and the influence on the rheological properties of the melt by the gear pump conveyance, so that this system cannot be used for PVC processing.

DE 197 41 674 A1(HAAKE GmbH), Mar. 25, 1999, discloses a method for determining the rheological properties of a plastic melt (mixture) in an extruder, with a melt flow being branched off to a measuring channel and the rheological properties being determined by means of pressure and temperature sensors. The disadvantageous aspect is in this system the formation of a measuring channel in the extruder cylinder, because the extruder cylinder then has a different temperature profile over its length and the Theological properties of a plastic melt will be influenced by such inhomogeneity in the temperature, so that distorted rheological properties are determined.

EP 0 899 556 A (GENERAL ELECTRIC), Mar. 3, 1999, discloses an online rheometer on the basis of branching off a melt flow for the determination of the rheological properties. The permanent loss of material during production is disadvantageous.

EP 0 347 055 A2 (RHEOMETRICS INC.), Dec. 20, 1989, discloses an online rheometer with a melt branch-off from the extruder and melt conveyance to the measuring device by means of gear pump. The disadvantageous aspect is the conveyance of the melt flow to the measuring device by means of a gear pump, which is why useless measuring results are determined in the case of PVC extrusion.

WO 01/32397 A1(TECHNOPLAST KUNSTSTOFFTECHNIK), May 10, 2001, discloses an online rheometer in which a melt stream is branched off. The disadvantageous aspect is the permanent loss of material, so that this system is not suitable for continuous production control.

US Pat. No. 4,213,747 (FRIEDRICH REINHARD), Jul. 22, 1980, discloses a method and an apparatus for monitoring the viscosity of a plastic melt with a branch-off and conveyance of the melt to the measuring apparatus by means of a gear pump. The disadvantageous aspect is the conveyance of the melt stream to the measuring apparatus by means of a gear pump, which is why useless measuring results are determined in the case of PVC extrusion.

WO 00/10794 (GREINER EXTRUSIONSTECHNIK; LANGECKER Gunter), Mar. 2, 2000, discloses a method and an installation for producing oblong items made of plastic with an integrated measuring device for closed-loop control of the gel degree or MFI/MVI index of the melt. As a result of the fact that the determination of the MFI/MVI index of the plastic melt principally occurs by means of a calibrated apparatus under standardized conditions (e.g. DIN 53735) which do not occur in a production plant and cannot be maintained, the value obtained under production conditions is not easily transferable to the value obtained under the standardized conditions. Moreover, an MFI/MVI index supplies only one single value on the viscosity curve, which in addition lies far outside of the value range which is technically possible for profile extrusion (e.g. shearing speed of MFI determination approx. 10 [1/s]; shearing speed range of extrusion approx. 10² to 10³ [1/s]). As a result, the measured value as proposed here is subsequently entirely useless as a control parameter. Furthermore, for the processing of PVC into profiles with high demand placed on the quality only twin-screw extruders without additional conveying devices (such as gear pumps) are used, so that the method generally outlined herein cannot be transferred and applied simply to profile extrusion. As a result of the fact that the rheological properties of a plastic melt made of PVC can be influenced by the “shearing prehistory” and the temperature, the applicability to polyolevines is limited and not applicable to PVC.

DE 197 15 630 (MICHAELI WALTER), 22 Oct. 22, 1998, discloses an apparatus and a method for determining rheological material data of polymers. A flow channel configured as a measuring section is coupled to an extruder. The material data are measured at very small pressure differences due to the short measuring section, which is why major uncertainties occur.

EP 0 238 796 (WERNER & PFLEIDERER), Sep. 30, 1987, discloses an apparatus and a method for producing a plastic material with defined properties, based on the principle of a lateral flow rheometer. The disadvantageous aspect is the permanent loss of material during the production.

US Pat. No. 6,463,810 B1 (INSTITUTE OF NUCLEAER ENERGY RESEARCH), Feb. 7, 2000, discloses a measuring apparatus for determining the mass rate of flow and flow speed in a system for low flow speeds. This system cannot be applied for rheological measurements and especially not for PVC melts.

DD 216 897 A1 discloses an extrusion system with integrated sensors for detecting the so-called morphological state of the processed plastic mass, a signal processing unit/computer unit for conversion into setpoint values for process parameters. Although the invention also relates to the processing of polyvinylchloride and the use of a continually operating viscosimeter, it remains unconsidered that in the case of PVC the flow properties cannot be described with a single viscosity value, but only with a multi-parameter viscosity function.

DE 3 713 400 A1 discloses a method and an apparatus for controlling extrusion rows by using a microprocessor. The extrusion method is controlled by using the mutual relationships between measured and controlled parameters of the extrusion method (cylinder temperatures, die temperatures, screw speed, draw-off speed) and between their calculated parameters (shearing speed, viscosity, first direct stress difference, die resistance, mass flow, critical shearing speed, swelling, characteristic dimension).

As a result of the fact that measurements are carried out only at one single place of the mass pressure of the plastic melt, namely as a measurement of the head pressure, the determination of the viscosity is not possible in the case of a plastic melt made of PVC, which shows an intrinsically viscous rheological behavior. An intrinsically viscous melt has a viscosity function which depends on several parameters (shearing energy, temperature, pressure and, in the case of PVC, a “shearing prehistory”), and cannot be described by a single viscosity value (η).

DE 1 454 787 A describes a “method for keeping constant the rate of flow of a material relating to the unit of time”. The object of the disclosed invention is to keep the flow rate constant. No attention is given to the rheological properties of the plastic melt (and they are also not monitored). In order to keep the rate of flow constant, two extruders are used which are situated behind one another, with the second extruder being equipped with a dosing screw and having a dosing function. Pressures in the melt are measured and processed as measuring signals only after the extruder by means of pressure sensors.

### SUMMARY OF THE INVENTION

It is the object of the present invention to ensure with the help of an easily applicable method and the associated devices the even quality of profile bars with complex profile geometry produced in the extrusion process, even if unavoidable and common fluctuations in the raw material or machine-induced fluctuations occur in the process parameters. The method must be applicable for the most commonly used material (PVC) and must consider the shearing energy, shearing prehistory and mass temperature occurring under production conditions.

This object is achieved in accordance with the invention in such a way that at least at two measuring points spaced from one another in the direction of flow of the plastic melt one control parameter each is calculated which is obtained from a predetermined function depending on the local pressure of the melt and a parameter representative of the flow speed of the melt in the extrusion die.

The relevant aspect is that during ongoing production the temperature of the plastic melt, the pressure reduction in the melt flow from the exit of the melt from the extruder up to the end of the extrusion die and the outlet speed of the plastic melt from the die are measured, processed into a meaningful parameter, evaluated statistically as a process parameter and is further processed for automatic control of the production plant within the terms of statistical closed-loop process control and monitoring.

The invention relates explicitly to the arrangement of sensors in the mass flow before the extrusion die and after the shaping of the mass in the die. This leads to the consequence that the viscosity of the melt is measured only in the melt flow in the extruder after complete plastifying (i.e. after leaving the plastifying volume of the screw and prior to entrance into the extrusion die) at only one single place, because there is no plastic melt in the closer sense any more in the molded profile after leaving the extrusion die which could be used for determining the viscosity. It is known that a PVC melt represents a so-called intrinsically viscous fluid, leading to the consequence that the PVC melt has a viscosity function depending on the shearing speed, temperature and, in addition, the “shearing prehistory”. A PVC melt cannot be described with a single “viscosity value”.

Known solutions differ essentially from the present invention in such a way that only one single value of a non-linear viscosity function dependent on several parameters can be measured with such arrangements of measuring sensors. With only one single viscosity value of an “unknown” viscosity function it is not possible to derive a strategy for process monitoring and control. In contrast to this, the present invention relates to the implicit, but reliable detection of the viscosity function over the entire shearing speed range which is relevant for the extrusion process. For explanation purposes it needs to be mentioned that the shearing speed range of the flowing plastic melt along the “flow channel” in an extrusion die is approx. 10²1/sec (entrance of melt into die) to approx. 10³ 1/sec (exit of melt from the die), i.e. where the mass pressure has already been reduced completely.

Measuring sensors for characterizing the melt property which process only one single shearing speed state do not supply useful results for plastic melts with intrinsically viscous flow behavior.

The present invention is based on the indirect detection of the viscosity function over the entire shearing speed range for random process settings.

DE 3 713 400 A1 relates to the material PVC. The method does not supply any useful parameters for the closed-loop control of the extrusion process for producing PVC profiles other than such which are conventionally used today and correspond anyway to the temperature and mass pressure sensors of the state of the art.

The present invention is dominated by the measurement of the melt properties and influencing the same for keeping the profile quality constant. By keeping the rate of flow constant (as described in DE 1 454 787 A), the problem concerning the evenness of the profile properties cannot be solved for most thermoplastic materials (including PVC). The disclosed solution thus does not affect the present invention in any way.

The parameters relevant for the extrusion process are the screw speed, the degree of filling of the screws (which can be influenced by means of dosing via the speed of dosing screw), the plastifying energy required for plastifying (formed from screw speed and screw torque), the thermal energy introduced into the extruder cylinder and extruder screws, the pressure consumption in the extrusion die (measured as mass pressure in the adapter between extruder flange and die flange), the temperature of the plastic melt (mass temperature, measured in the adapter between extruder flange and die flange), the die tempering and extrusion speed and the output rate of extrudate from the die. These parameters are measured in a conventional manner and displayed in a suitable way. The quality of the profile bars produced in the extrusion process is evaluated externally by means of geometrical measuring devices and optical, chemical and physical test methods. In accordance with the state of the art, manual adjustments of the parameters are made in case of deviations which would lead to an impairment of the quality or uselessness. This leads to the disadvantage that partly long periods of time lie between the point in time when the deviation occurred and the recognition of the deviations, meaning that a large quantity of rejected material can be produced until a correction becomes effective. With the parameters monitored in the production process alone it is not possible to provide a closed-loop control of the plant according to quality criteria of the manufactured profile. In order to enable this, a new parameter is defined, the so-called extrusion count “EZ”, with which the rheological properties of a plastic melt can be described in a simple manner for a defined plastic material under defined production conditions on an extruder with a defined extrusion die. It can subsequently be used as a control parameter for automatic control of the extrusion plant.

This new parameter, which is designated as extrusion count EZ, describes indirectly a viscosity function of the plastic melt under production conditions. In the classic sense, the Theological properties of a plastic melt are described by means of a viscosity function which is usually based on a simplified model law. The viscosity function according to the Carreau model shall be mentioned as an example. The precise determination of an “absolute” viscosity function with suitable measuring apparatuses under production conditions is complex and only represents a momentary reflection. For this reason, the determination of an “absolute” viscosity function in the classic sense is omitted in favor of an “auxiliary function” which actually describes the process. A viscosity function describes the connection of the viscosity of a melt with the shearing speed relating to a specific (melt) temperature.

$$\begin{matrix}η ( {T}_{M} ) = f ( \begin{matrix}\cdot \\ γ\end{matrix} ) [ P a \cdot s ] & ( 1 ) \\ EZ ( T , {v}_{A} ) = {\sum }_{i = 1}^{n} ( {p}_{i} \cdot {\overline{v}}_{i} ) [ bar \cdot m / min ] & ( 2 ) \\ {\overline{v}}_{i} = \frac{{V}^{*}}{{A}_{i}} [ m / min ] & ( 3 )\end{matrix}$$

As a result, the extrusion count EZ is only a function of the mass temperature T_{M} and the draw-off speed V_{A} for a defined extrusion die and a defined extrusion plant.

The pressure consumption of the extrusion die is measured by means of conventional pressure sensors, with at least one pressure sensor being required in the system (adapter). In a preferred embodiment, additional pressure levels are measured with at least one additional pressure sensor in the flow channel of the extrusion die, which levels can be used for a more precise determination of the pressure consumption and the allocation to the respective position in the extrusion die. The volume flow \dot{V} in the extrusion die is calculated from the outlet cross section and the draw-off speed V_{A} (=outlet speed of extrudate from the extrusion die).

The method in accordance with the invention and the required devices for the automatic control of the extrusion process work as follows: A “master curve” is determined and saved at the beginning of a production with a new extrusion die. The extrusion count EZ, as a function of the mass temperature and the draw-off speed, is determined under production conditions. The profile quality is detected for each defined setting and the threshold values are determined within which the profile quality still meets the requirements, and a production target value is determined as “mean value”. The control algorithm tries to reach and hold this mean value as a target value. Deviations from the target value are analyzed by means of trend analysis according to statistical methods. As long as the determined extrusion count lies within the preselected threshold values no action will be taken. A warning message or a warning signal will be issued only when so-called warning thresholds are reached. On the other hand, when an intervention threshold is reached there will be information about a change to be performed for one or several production parameter(s) (e.g. increase mass temperature, reduce screw speed, increase draw-off speed).

### BRIEF DESCRIPTION OF THE DRAWINGS

The invention is now explained in closer detail by reference to the enclosed drawings, wherein:

FIG. 1 schematically shows an extrusion plant in an axonometric view;

FIG. 2 schematically shows an extrusion plant in a side view;

FIG. 3 shows a diagram representing a typical extrusion curve;

FIG. 4 shows embodiments in representations according to FIG. 2;

FIG. 5 shows embodiments in representations according to FIG. 2;

FIG. 6 shows further diagrams for explaining the invention, and

FIG. 7 shows further diagrams for explaining the invention.

### DETAILED DESCRIPTION OF THE PREFERRED EMBODIMENTS:

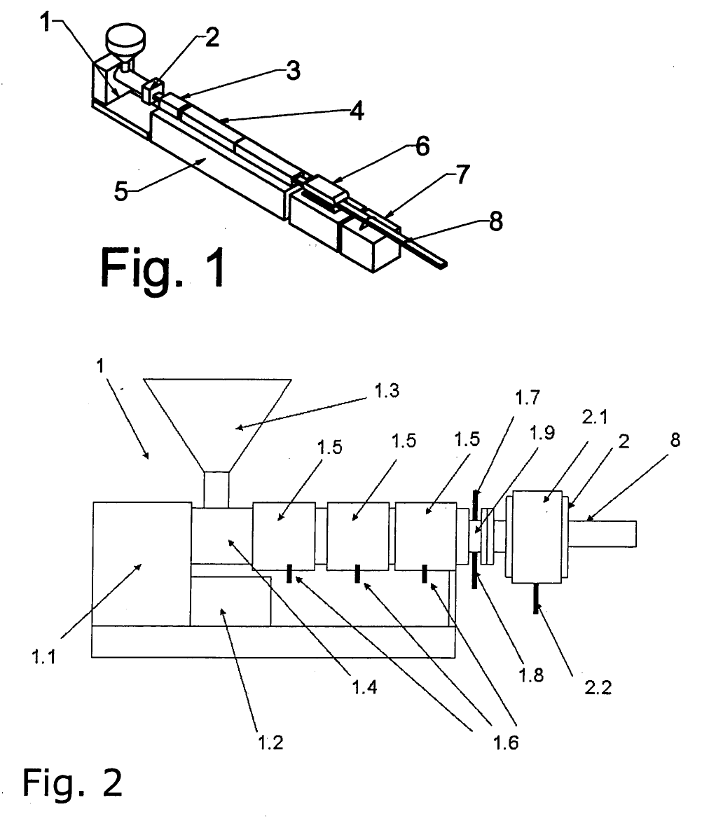

FIG. 1 shows an extrusion plant consisting of an extruder 1, the extrusion die 2, the dry calibrating tool 3, the water-bath or vacuum-tank calibration 4, the vacuum calibrating table 5, the profile caterpillar pull-off 6, the apparatus 7 for cutting the profile to length, and the produced profile 8.

FIG. 2 shows the part of an extrusion plant which is the most important one with respect to the process technique and consists of the extruder 1 with the gearing 1.1, the drive motor 1.2, the feeding means 1.3 for the material (funnel), the extruder cylinder 1.4 (with extruder screws not shown in closer detail), the heating devices 1.5 (configured as a heating and cooling body), the temperature sensors 1.6 for determining the extruder cylinder temperature, the temperature sensor 1.7 for determining the mass temperature of the melt in the adapter 1.9, the pressure sensor 1.8 for determining the melt pressure in the adapter 1.9 and the extrusion die 2, comprising the heating devices 2.1 and the temperature sensors 2.2 for determining the extrusion die temperature.

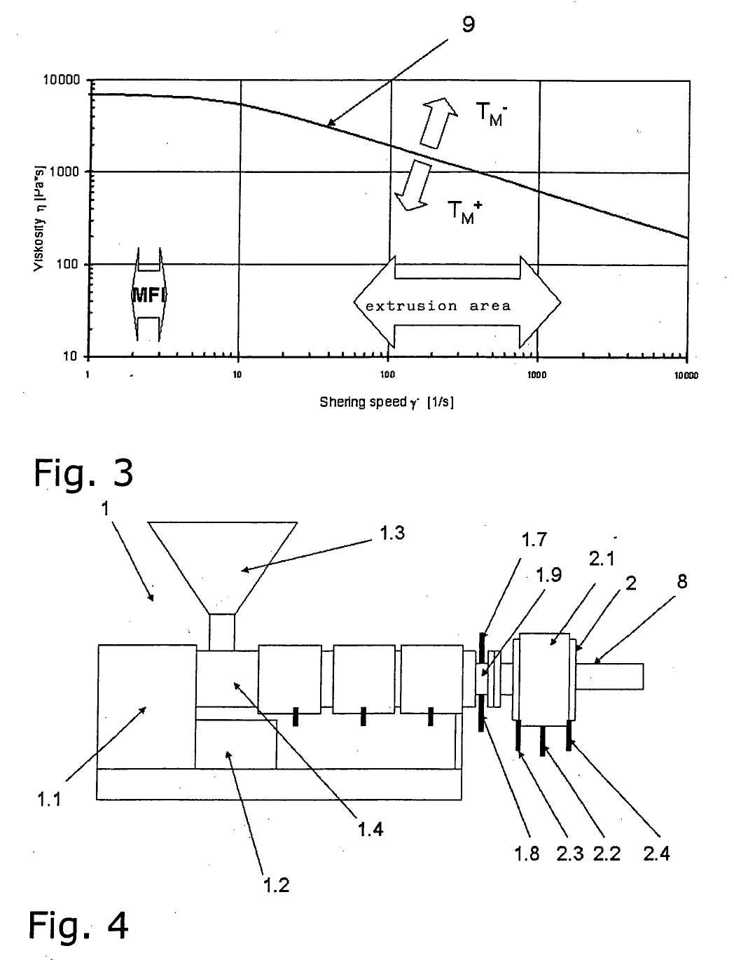

FIG. 3 shows a typical viscosity curve 9 for PVC melting and the range of the extrusion in the shearing speed range of approx. 10² to 10³ [1/s] and the shearing speed range for determining the MFI value. The viscosity curve changes by changing the melt (mass) temperature; the viscosity decreases when the temperature rises and vice-versa. The inclination of the viscosity curve is additionally influenced by changing the introduction of shearing energy (“shearing prehistory”).

FIG. 4 shows an extrusion plant in accordance with the invention with additional pressure measuring sensors 2.3 and 2.4 in the extrusion die 2 for determining a more precise pressure consumption in the extrusion die. Said pressure measuring sensors are provided at locations where a direct contact with the melt is possible, but is situated at a position relating to the end product where there is a subordinate demand on the surface quality (e.g. freedom from striations, gloss).

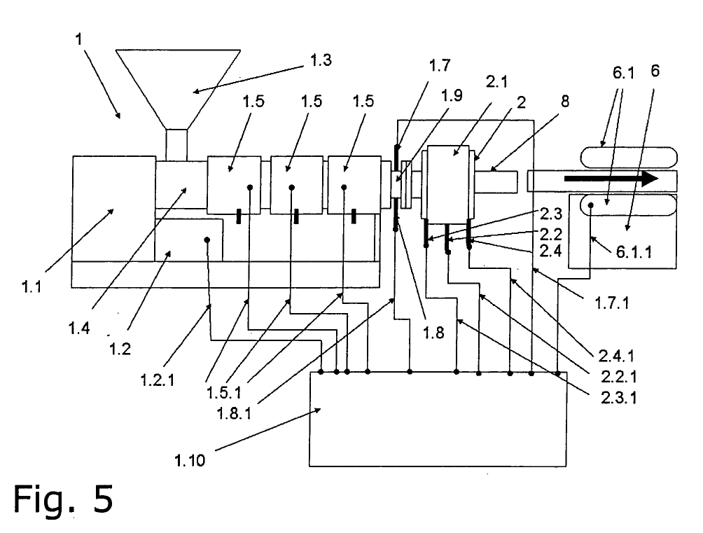

FIG. 5 shows the extrusion plant in accordance with the invention with the controller 1.1.0. The following values are detected: motor torque 1.2.1, cylinder heating output 1.5.1, mass temperature 1.7.1, mass pressure 1.8.1, melt pressures 2.3.1 and 2.4.1 in the extrusion die, the die temperatures 2.2.1 and draw-off speed 6.1.1 from drive unit 6.1 of the profile caterpillar pull-off 6.

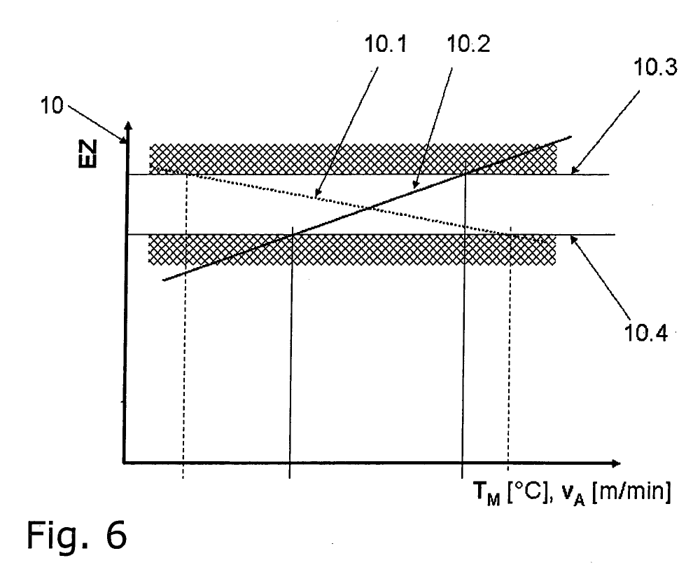

FIG. 6 shows a schematic representation of the progress of the extrusion count EZ 10 as a function of the mass temperature 10.1 and as a function of the draw-off speed 10.2 and the upper threshold value 10.3 and the lower threshold value 10.4.

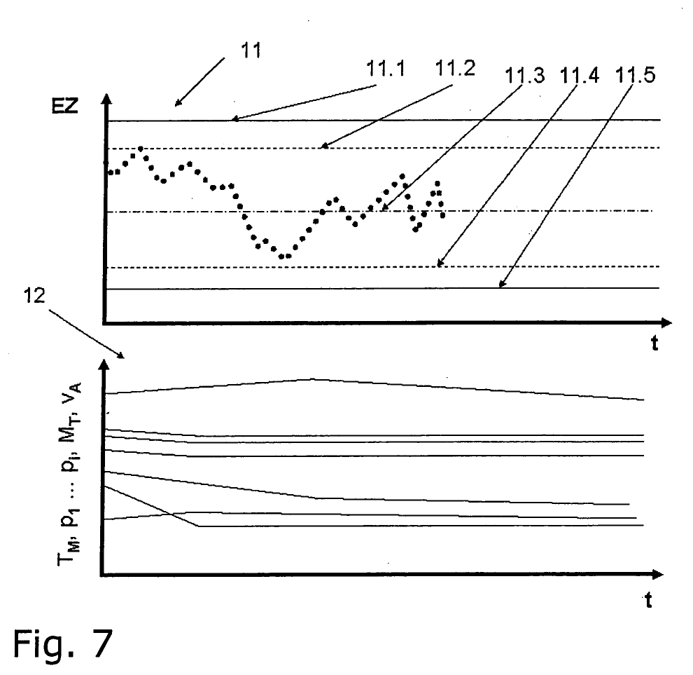

FIG. 7 schematically shows a possibility of closed-loop process control by means of closed-loop process control card technology 11, with the upper intervention threshold 11.1 and the lower intervention threshold 11.5, with the upper warning threshold 11.2 and the lower warning threshold 11.4, and the target value 11.3 of the extrusion count EZ, and the progress of different process parameters in a histogram 12 in a schematic view.

The present invention describes a method and the necessary devices for automatic process and quality monitoring as well as an integrated closed-loop control system for an extrusion process for producing profile bars made of thermoplastic material, preferably PVC.

1. A method for producing profiles made of thermoplastic material, preferably PVC, in which plastic granulate or powder is plastified in an extruder and is pressed through an extrusion die in order to produce a profile strand with a predetermined cross section, with automated process and/or quality monitoring being performed in order to ensure even quality of the produced profile, such that measured values on the state of the plastic melt are recorded in the extruder and/or extrusion die and are processed, wherein at least at two measuring points spaced from one another in the direction of flow of the plastic melt one control parameter each is calculated which is obtained from a predetermined function depending on the local pressure of the melt and a parameter representative of the flow speed of the melt in the extrusion die.

2. A method according to claim 1, wherein the control parameter can be represented as a function of the product from local pressure of the melt and flow speed of the melt.

3. A method according to claim 1, wherein a quotient from a mass flow determined from the screw speed and a cross-sectional surface at the measuring point is taken as a parameter which represents the flow speed of the melt in the extrusion die.

4. A method according to claim 1, wherein a quotient from a mass flow determined from the draw-off speed and a cross-sectional surface at the measuring point is taken as a control parameter which represents the flow speed of the melt in the extrusion die.

5. A method according to claim 1, wherein the temperature is determined in addition at the measuring points.

6. A method according to claim 1, wherein the at least one measuring point is arranged at the upstream end of the extrusion die and at least one further measuring point is arranged at the downstream end of the extrusion die.

7. A method according to claim 1, wherein the at least one measuring point is arranged directly downstream of the extruder screw and preferably upstream of an adapter.

8. A method according to claim 1, wherein the several control parameters obtained at different measuring points are linked additively into a main control parameter which is used primarily for closed-loop process control.

9. A method according to claim 1, wherein fuzzy logic algorithms are used for closed-loop control.

10. A method according to claim 1, wherein neuronal networks are used for closed-loop control.

11. An apparatus for the closed-loop control of a plant for producing profiles made of thermoplastic material, preferably PVC, in which plastic granulate or powder is plastified in an extruder and is pressed through an extrusion die in order to produce a profile strand with a predetermined cross section, in which measurement transducers are provided for determining the pressure in the melt in order to determine control parameters which are used for the closed-loop control of the extrusion process, comprising a controller calculating a control parameter at at least two measuring points spaced from one another in the direction of flow of the plastic melt each contro parameter being obtained from a predetermined function depending on the local pressure of the melt and a parameter representative of the flow speed of the melt in the extrusion die.

12. An apparatus according to claim 11, wherein a temperature sensor is further provided at at least one measuring point.

13. An apparatus according to claim 11, wherein at least one measuring point is arranged at the upstream end of the extrusion die and at least one further measuring point is arranged at the downstream end of the extrusion die.

14. An apparatus according to claim 11, wherein at least one measuring point is arranged directly downstream of the extruder screw and preferably upstream of an adapter.

15. An apparatus according to claim 11, wherein the controller additively links several control parameters obtained at different measuring points into a main control parameter which is used primarily for closed-loop process control.
